(19) United States
(12) Patent Application Publication
(10) Pub. No.: US 2005/0275360 A1
(43) Pub. Date: Dec. 15, 2005

(54) Motor with mechanism for storing mechanical energy for portable applications

(76) Inventor: Charles F. McCord JR., Carvdlis, OR (US)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/865,090

(22) Filed: Jun. 9, 2004

(51) Int. Cl. H02P 1/00

(52) U.S. Cl. 318/150; 318/59

(57) ABSTRACT

A mechanical motor for collecting, storing, and using mechanical energy instead of electrical energy and for imparting kinetic energy (e.g., rotational movement) to move components of devices that need energy. The mechanical motor includes a drive shaft that is coupled to the component. A drive mechanism is coupled to the drive shaft for imparting kinetic motion thereto. A wind-up mechanism (e.g., a handle) is provided for use by a person to apply human energy to the motor. An energy storage mechanism is coupled to the handle for converting human energy into mechanical energy and for storing the mechanical energy. A switch is optionally provided for turning the mechanical motor on and off. When turned on, the mechanical motor converts the stored mechanical energy into motion that can be applied to move the components of the devices (e.g., portable computing devices).

### BACKGROUND OF THE INVENTION

The use of portable computing devices is widespread and pervades into all areas of our society. There is hardly a place in society where one can go, where one does not see people with laptop computers, personal digital assistants, pocket personal computers, etc. The portable computing devices are commonly found in the workplace, in restaurants, in mass transportation (e.g., in trains, airplanes, etc.), in shopping centers, in schools, campuses and universities, in recreation areas, in virtually every venue of society. For example, coffee shops are often now equipped with an Internet connection so that patrons can use their portable computing devices to surf the Web, check electronic mail, or simply link to a server at a remote location to do work.

While providing convenience and increasing productivity, portable computing devices do suffer from disadvantages not encountered by desktop computing devices. One of these disadvantages is the limited amount of operating time. The operating time is dependent upon and measured by the battery life of the batteries utilized to run these portable computing devices. For example, some of us may have encountered the situation, where the use of a laptop computer had to be prematurely terminated because the laptop computer was low on batteries. Other times, data may have been lost because the batteries ran out of power, thereby causing the shutdown of the computer or other system failure.

To address these concerns, the designers of portable computing devices attempt to optimize the design of the components used in the portable computing devices to conserve power. Consequently, the design of portable applications, such as laptop computers and components used in the laptop computers, is difficult from multiple perspectives. One of the challenges faced by designers of portable applications is the limited power budget. A power budget is similar to a fiscal budget in that it allocates power to the various components as a fiscal budget allocates funds to different projects or uses. Unlike desktop applications where the computing units have a virtually unlimited supply of power from a wall socket, portable applications usually depend on battery power, which at best lasts several hours. Even with the advances in the types of batteries and portable power supplies, the power is still limited. Moreover, it appears that the advances in battery technology that provide more power have been outpaced by the addition of power-hungry circuits and components that support features demanded by the insatiable consumer. Consequently, the overall system design of portable devices and the design of all of the individual components utilized therein are made more difficult because of the constraint in the power budget.

When one analyzes the power budget, many mundane tasks consume a considerable amount of the entire power budget. For example, most laptop computers require some type of fan to cool the electronics housed therein. The motor to operate the fan consumes some amount of the power budget. As another example, the motor that turns or spins the hard drive in a laptop consumes a considerable amount of the power budget. It would be desirable to somehow provide power for these tasks while at the same time conserving the energy or power budget.

Based on the foregoing, there remains a need for a motor with a mechanism for storing mechanical energy for portable applications mechanism that overcomes the disadvantages set forth previously.

### SUMMARY OF THE INVENTION

According to one embodiment of the present invention, a mechanical motor for collecting, stroing, and using mechanical energy instead of electrical energy and for imparting kinetic energy (e.g., rotational movement) to move components of devices that need energy is described. The mechanical motor includes a drive shaft that is coupled to the component. A drive mechanism is coupled to the drive shaft for imparting kinetic motion thereto. A wind-up mechanism (e.g., a handle) is provided for use by a person to apply human energy to the motor. An energy storage mechanism is coupled to the handle for converting human energy into a mechanical energy and for storing the potential energy. A switch is optionally provided for turning the mechanical motor on and off. When turned on, the mechanical motor converts the stored mechanical energy into motion that can be applied to move the components of the devices (e.g., portable computing devices).

According to one embodiment of the present invention, the mechanical motor is utilized to drive a fan.

According to another embodiment of the present invention, the mechanical motor is utilized in a media player to spin or rotate media (e.g., spinning digital media).

According to yet another embodiment of the present invention, the mechanical motor is utilized to move one or more components in a printing/rendering apparatus.

According to another embodiment of the present invention, the mechanical motor is utilized in a tape-type media player to advance a tape-type media (e.g., an audio cassette).

### BRIEF DESCRIPTION OF THE DRAWINGS

The present invention is illustrated by way of example, and not by way of limitation, in the figures of the accompanying drawings and in which like reference numerals refer to similar elements.

FIG. 1 illustrates a fan for cooling components that employs a mechanical motor to provide energy to drive the fan according to one embodiment of the invention.

FIG. 2 illustrates a media player that employs a mechanical motor to rotate or spin a media according to one embodiment of the invention.

FIG. 3 is a block diagram illustrating in greater detail components of the media player of FIG. 2 according to one embodiment of the invention.

FIG. 4 is a flowchart that describes the operation of the mechanical motor of FIG. 2 according to one embodiment of the invention.

FIG. 5 illustrates a rendering/printing apparatus that employs a mechanical motor to move components therein according to one embodiment of the invention.

FIG. 6 illustrates a tape-type media player that employs a mechanical motor to advance a type-type media according to one embodiment of the invention.

### DETAILED DESCRIPTION

Motor with a mechanism for storing potential energy (e.g., mechanical energy) for portable applications and methods related thereto are described. In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

Fan Application

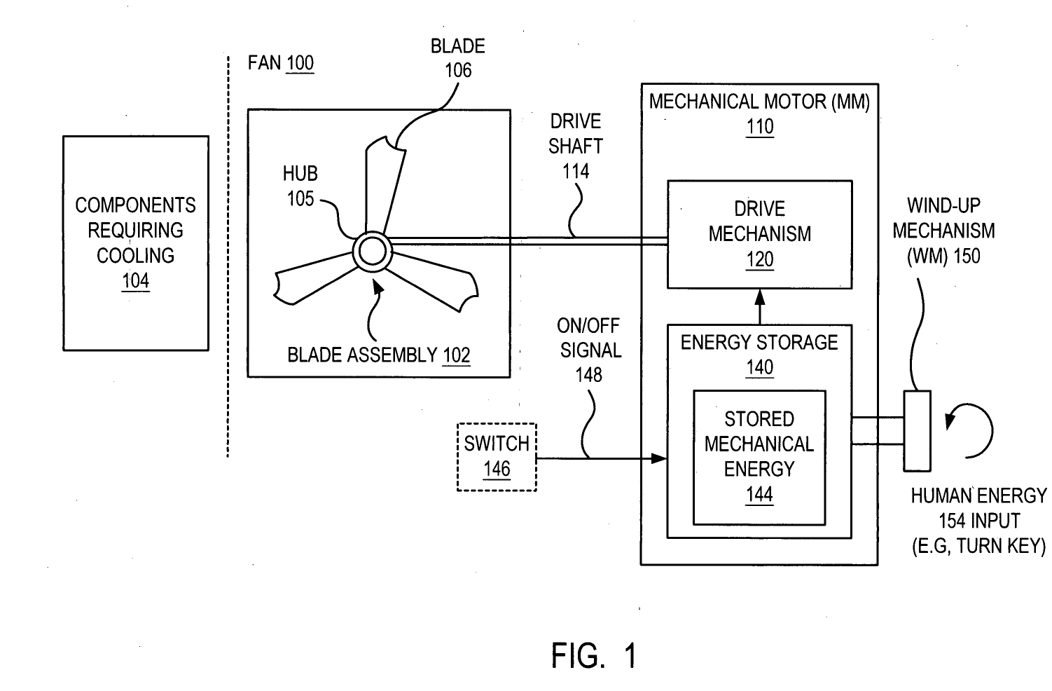

FIG. 1 illustrates a fan 100 for cooling components 104. The fan 100 employs a mechanical motor (MM) 110 to provide energy to operate the fan 100 according to one embodiment of the invention. The fan 100 is disposed proximal to components 104 that require cooling (e.g., electronic components). In one example, the fan 100 is utilized to cool the components of a portable electronic device. When the device is a laptop computer, electronic components therein that may require cooling can include, but is not limited to, a power supply, a motherboard, circuits mounted on the motherboard (e.g., a chip set, integrated circuits, random access memory (RAM) module), expansion cards disposed on the motherboard, hard drive, floppy disk drive, CD/DVD-ROM drive, and other components.

The fan 100 includes a blade assembly 102 that has a hub 105 and a plurality of blades 106 that extend from the hub 105. The mechanical motor 110 includes a drive mechanism 120 for providing rotational drive to a drive shaft 114, which engages the blade assembly 102.

The mechanical motor 110 also includes an energy storage component 140 (labeled “energy storage” in FIG. 1) and a wind-up mechanism (WM) 150. The energy storage component 140, which is also referred to herein as “energy storage mechanism,” stores potential energy 144 (e.g., human energy 154 imparted by a user). The potential energy 144 is also referred to herein as “stored mechanical energy,” or “mechanical energy.” The mechanical energy 144 is imparted to the energy storage component 140 through the wind-up mechanism (WM) 150.

The wind-up mechanism (WM) 150 can be, but is not limited to, a crank or handle. An operator imparts human energy 154 to the energy storage mechanism 140 by turning or winding-up the wind-up mechanism 150. The energy storage mechanism 140 stores the human energy as mechanical or potential energy 144.

A switch 146 is optionally provided for turning the mechanical motor 110 on and off. The switch 146 can be, for example, a mechanical switch or an electronic switch. In this embodiment, the switch 146 selectively asserts the activation signal 148 (i.e., “ON/OFF signal 148”) to turn the fan 100 on and de-asserts the activation signal 148 to turn the fan 100 off.

The energy storage component 140 includes an input for receiving the activation signal 148 (e.g., an ON/OFF signal) that may be provided by the switch 146 or other source (e.g., a computer system or a power management unit). Based on the activation signal 148, the energy storage component 140 selectively converts the stored mechanical energy into kinetic energy (e.g., in the form of rotational motion) to activate the drive mechanism 120. Once activated, the drive mechanism 120 turns the drive shaft 114, which then turns the blade assembly 102, thereby providing the desired cooling effect.

In one embodiment, the energy storage component 140 is implemented with a spring-based storage that is commonly found in mechanical watches or music boxes. Examples of these spring-based storage mechanisms are described in U.S. Pat. No. 6,500,005, U.S. Pat. No. 4,464,969, and U.S. Pat. No. 6,582,273. The energy storage component 140 can be any mechanism that can store human energy as potential energy or mechanical energy and that can be selectively actuated to convert the potential energy into kinetic energy (e.g., rotational movement).

The coupling between the wind-up mechanism 150 and the energy storage component 140, the coupling between the energy storage component 140 and the drive mechanism 120, the coupling between the drive mechanism 120 and the drive shaft 114, and the coupling between the drive shaft 114 and the blade assembly 102 can be any gearing systems that are known by those of ordinary skill in the art. For example, the coupling can be, but is not limited to a rack and pinion gear, a spur gear, a bevel gear, and a worm gear.

Spinning Media Applications

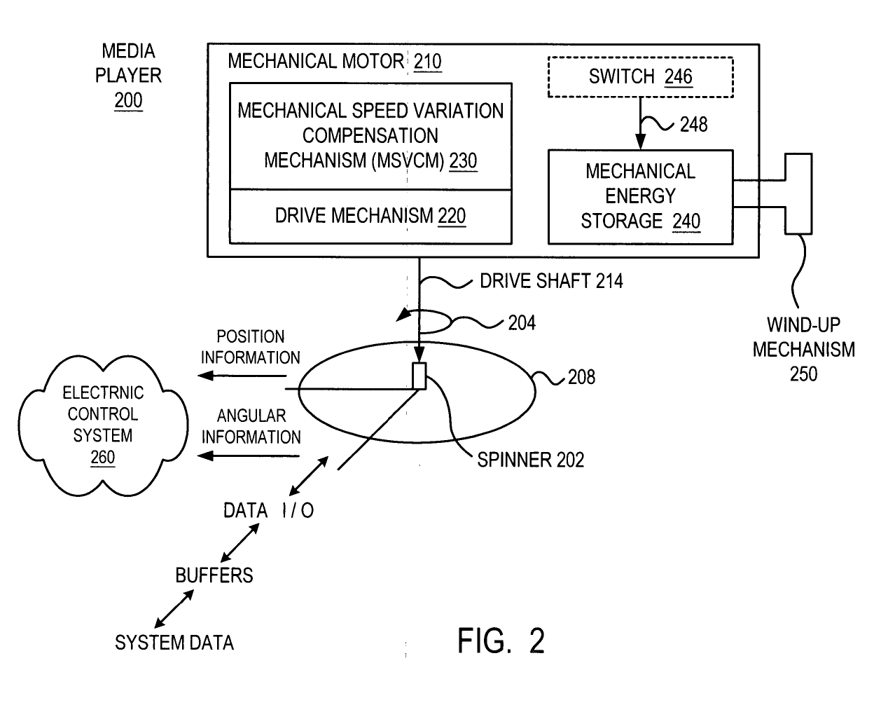

FIG. 2 illustrates a media player 200 that employs a mechanical motor (MM) 210 to spin or rotate a spinning-type media 208 (e.g., compact discs, floppy disks, records, etc.) according to one embodiment of the invention. The media player 200 may be, for example, a compact disc player, a DVD player, record player, a video game player or other media player that rotates or spins its media.

In this application, rotational energy 204 is needed to spin a media 208 (e.g., compact discs, floppy disks, DVDs, video game discs, etc.). The media player 200 includes a spinner 202 for physically engaging the media 208 and for spinning or rotating the media 208.

The mechanical motor 210 includes a wind-up mechanism 250, a mechanical energy storage component 240, a drive mechanism 220, a drift shaft 214, and optionally a mechanical speed variation compensation mechanism (MSVCM) 230, and a switch 246. A wind-up mechanism (e.g., a handle) 250 can be turned or wound by a user in order to input human energy into the motor 210. As the user turns the handle 250, human energy is imparted to a mechanical energy storage component 240 and stored as potential energy (hereinafter referred to as “mechanical energy”).

In one embodiment, the mechanical energy storage component 240 can be implemented as a spring or other mechanism that can store mechanical energy and that can be selectively actuated to convert the mechanical energy into kinetic energy (e.g., rotational motion).

The mechanical energy storage component 240 also includes an input for receiving an activation signal 248 (e.g., an ON/OFF signal) that may be provided by the switch 246 (e.g., a mechanical switch or an electronic switch) or other source (e.g., a computer system or a power management unit). The mechanical motor 210 can optionally include the switch 246, as shown, or the switch may be external to the mechanical motor, as shown in FIG. 1.

Based on the activation signal 248, the mechanical motor 210 employs the drive mechanism 220 to selectively convert the stored mechanical energy in mechanical energy storage 240 into kinetic energy (e.g., in the form of rotational motion) to activate or rotate the drive shaft 214. The drive mechanism 220 imparts rotational energy 204 to the drive shaft 214, which in turn rotates the spinner 202. The spinner 202 engages and rotates or spins the media 208.

In one embodiment, the mechanical energy storage component 240 is implemented with a spring-based storage. However, the energy storage component 240 can be any mechanism that can store human energy as potential energy or mechanical energy and that can be selectively actuated to convert the potential energy into kinetic energy (e.g., rotational movement).

The motor 210 can also include a mechanical speed variation compensation mechanism (MSVCM) 230 for mechanically compensating for variations in speed provided by the mechanical energy storage 240. For example, the MSVCM 230 mechanically reduces the speed variation provided by the motor 210 by mechanically compensating for variations in the rotational speed of the media 208. The construction and operation of these mechanical speed variation compensation mechanisms, which are also referred to as “mechanical speed governors,” are known to those of ordinary skill in the art and will not be described in greater detail herein. An example of a mechanical speed variation reduction mechanism 230 is described in U.S. Pat. No. 4,458,573.

If multiple drive shafts are utilized, an energy transfer mechanism for translating the motion of a first shaft to corresponding motion of a second shaft may be employed. The mechanical motor 210 can also include an energy transfer mechanism for translating the motion of an internal shaft, for example, to corresponding motion of the drive shaft 214. The energy transfer mechanisms can increase or decrease the rotational speed of the respective drive shafts and may include one or more gears or a gear system that are known by those of ordinary skill in the art. The coupling between the drive shafts and energy transfer mechanisms (e.g., gears) can be any gearing systems that are known by those of ordinary skill in the art.

The coupling between the wind-up mechanism 250 and the mechanical energy storage component 240, the coupling between mechanical energy storage component 240 and the drive mechanism 220, the coupling between the drive mechanism 220 and the drive shaft 214, and the coupling between the MSVCM 230 and the drive mechanism 220 can be any gearing systems that are known by those of ordinary skill in the art.

In addition to the components (e.g., electronics, read head, write head) commonly found in spinning media players for reading or writing data to the spinning media (e.g., a digital media), the media player 200 can include an electronic control system (ECS) 260 according to the invention for 1) electrically compensating for speed variations provided by motor 210 and for 2) providing an interface between the rate at which data can be read from or written to the digital media and the varying rate of rotation provided by motor 210.

Electronic Control System (ECS) 260

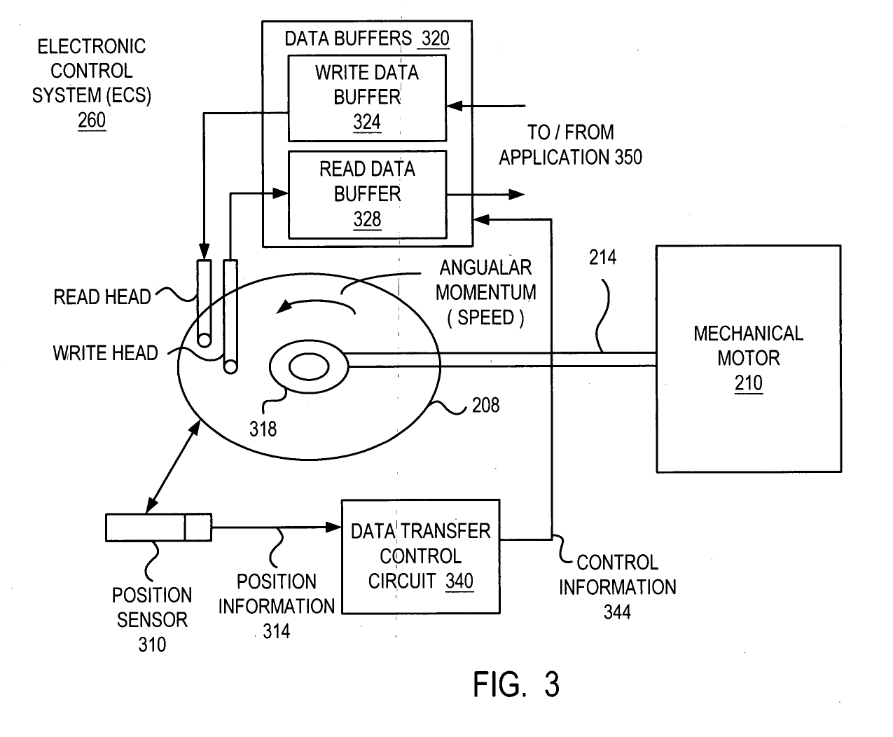

FIG. 3 is a block diagram illustrating in greater detail components of the media player of FIG. 2 according to one embodiment of the invention. The electronic control system (ECS) 260 can include data buffers, position sensors for feedback of position information of the media, and control electronics for electrically compensating for speed variations in the spinning media. Specifically, the ECS 260 includes a position sensor 310, data buffers 320 (e.g., write data buffers 324 and read data buffers 328), and a data transfer control circuit 340.

As described previously, the ECS 260 utilizes the data transfer control circuit 340 to electrically compensate for variations in speed of the spinning media 208. The electronic control system 260 electrically compensates for varying or inadequate data transfer rates (e.g., the rate to read data from the media and the rate to write data to the media) to accommodate data rates expected by a computer system.

The position sensor 310 provides position information 314 regarding the current position of the media 208. For example, indicia may be printed on the media 208 so that the sensor can read the indicia and based thereon determine the position of the media 208 with respect to predetermined reference markings 318. The electronic control system 260 electrically compensates for variations in the rotational speed of the media 208 by utilizing the feedback (e.g., position information and angular information) provided by the position sensor 310.

The data buffers 320 can also be utilized to synchronize the data transfer rates expected by an application or system 350 and the maximum data transfer rates supported by the mechanical motor 210 according to the invention. In the event that the maximum data transfer rates supported by the mechanical motor 210 are not sufficient to meet the data transfer rates expected by the application or system 350, the data buffers 320 can be utilized to compensate for the inadequate speed and also for variations in speed.

Based on this position information 314, the electronic control system 260 can use data buffers 320 to provide data to a system 350 at an acceptable rate, expected rate, or a required rate. For example, in the case of writing data to the media 208, when the speed of the media is too slow, the data can be written first to write data buffers 324 at the system rate (i.e., the rate that the system is accustomed to transferring data for a write operation). Once a predetermined amount of data has been written to the write data buffers 324, the data can then be read from the write data buffers 324 and written to the media 208 at a slower rate, at a changing rate, or at a slower and changing rate of the spinning media 208 supported by the mechanical motor 210.

For example, in the case of reading data from the media 208, when the speed of the media 208 is slower than that needed to accommodate the system 350, the data can be first read from the media 208 to the read data buffers 328 at the slower rate or varying rate. Once a predetermined amount of data has been obtained, the data can then be read from the read data buffers 328 and provided to the system 350 at a rate expected by the system 350. For example, the rate at which data is read by the system 350 can be faster than, more constant than, or both faster than and more constant than the rate supported by the mechanical motor 210 according to the invention.

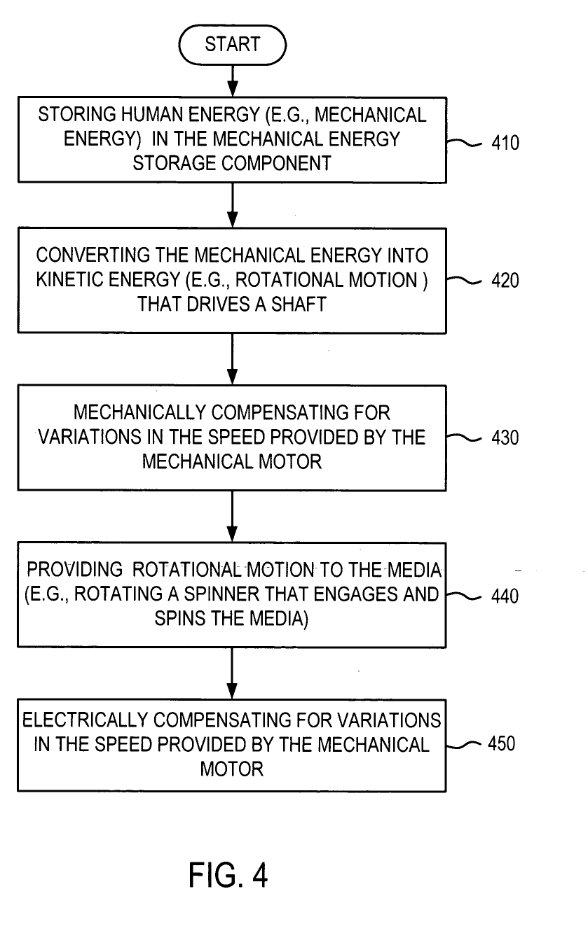

FIG. 4 is a flowchart that describes the operation of the mechanical motor 210 of FIG. 2 according to one embodiment of the invention. In step 410, human energy (e.g., mechanical energy) is stored in the mechanical energy storage component 240. For example, a user applies human energy to a wind-up mechanism 250 to store mechanical energy in mechanical energy storage component 240 (e.g., a spring). In step 420, the mechanical energy is converted into kinetic energy (e.g., rotational motion) that drives a shaft 214. In step 430, variations in the rotational motion or speed provided by the 210 motor 210 are mechanically compensated (e.g., by employing MSVCM 230). In step 440, rotational motion is provided to the media (e.g., by rotating a spinner that engages and spins the media). In step 450, variations in the speed provided by the mechanical motor 210 are electrically compensated. For example, the electronic control system 260 can be utilized to read data from or write data to the media in a manner that employs data buffering to accommodate the read and write operations even though the speed provided by the mechanical motor 210 may be less than the speed provided by an electronic motor.

It is noted that the mechanical motor that operates from human energy according to the invention off-loads some of the more mundane tasks (e.g., operating a fan or spinning a media) from the electrical power budget. In this manner, the other system components can operate for a longer period of time since the budget originally allocated to the components that are now powered by the mechanical motor can be allocated to the remaining components that operate on electrical power. For example, the mechanical motor according to the invention may be advantageously utilized in portable applications (e.g., a portable computer, portable printer, portable tape player, portable disc player, portable printer, etc.) or other applications that have a limited power budget (e.g., applications that are powered by a battery).

One aspect of the mechanical motor according to the invention is the provision of mechanisms (both mechanical and electrical) to compensate for variations in the speed provided by the mechanical motor. These mechanisms enable the reading or playback of data at a speed that meets 1) an acceptable minimum of a particular system (e.g., below the requirements of a computer system or application) or 2) that is acceptable to a user (e.g., a play back speed for an audio cassette tape that is of an acceptable audio quality) even though the speed provided by a mechanical motor, without these mechanisms, may not meet predetermined requirements or quality standards.

Printer Applications

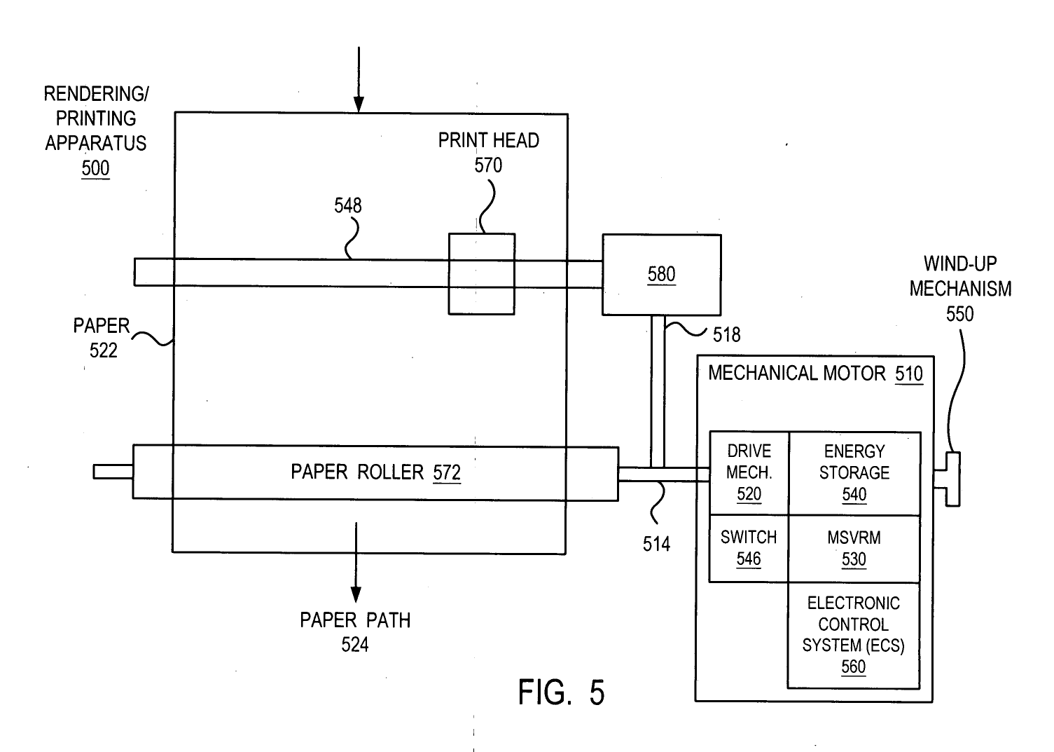

FIG. 5 illustrates a rendering/printing apparatus 500 that employs a mechanical motor 510 to move components therein according to one embodiment of the invention. The mechanical motor (MM) 510 drives or moves different components (e.g., a paper roller, print heads, etc.) in the rendering apparatus, which can be for example, a printer 500 (e.g., an inkjet printer, laser printer, facsimile machine, etc.). The rendering apparatus 500 includes printer components (e.g., 570, 572) that require motion (e.g., need to be moved or rotated). For example, one component is a paper roller 572 for advancing paper 522 along a paper path 524. Another component is a print head 570 that prints or deposits ink onto the paper 522.

The motor 510 includes a wind-up mechanism 550, a mechanical energy storage component 540, a drive mechanism 520, and optionally a mechanical speed variation compensation mechanism (MSVCM) 530, an electronic control system 560, and a switch 546.

The construction and operation of the mechanical motor (MM) 510 are similar to the mechanical motors (110, 210) according to the invention described previously. For example, the above-noted components of motor 510 operate and function in a manner similar to those elements described previously with common suffix numerals. For the sake of brevity, this description will not be repeated herein.

A mechanical motor 510 according to the invention is coupled to the paper roller 572 through a drive shaft 514 to rotate the paper roller 572. The mechanical motor 510 according to the invention may also be coupled to the print head 570 through a print head drive mechanism (e.g., a movable belt or rotating shaft) 548, an energy transfer mechanism 580, and drive shafts (e.g., 514, 518). The mechanical motor 510 can be utilized to move the print head 570 along the x-axis in either a right direction or a left direction. In one embodiment, a belt is disposed parallel to the support bar and connects to the print head 570 and the energy transfer mechanism 580. The energy transfer mechanism 580 rotates the belt, thereby moving the print head 570. Alternatively, the support rod includes grooves that move the print head 570. The energy transfer mechanism 580 and shafts 514, 518 can be implemented with the mechanisms described in U.S. Pat. No. 6,533,387.

In one embodiment, the mechanical motor according to the invention can be used for advancing print media (e.g., paper) and also for carriage motion (e.g., moving the print head) as described in U.S. Pat. No. 6,533,387 entitled, “Inkjet Printing System Using Single Motor For Print Media Advance And Carriage Motion”.

The mechanical motor 510 can optionally include a mechanical speed variation compensation mechanism (MSVCM) 530 for mechanically compensating for variations in speed provided by the MM 510. For example, the MSVCM 530 can reduce the amount of speed variation so that the MM 510 can provide a more constant drive or rotational motion to drive shafts 514, 518, for example.

Also, the printer 500 can optionally include an electronic control system 560 for 1) electrically compensating for variations in the speed provided by the MM 510 (e.g., by reducing the variations in the speed) and for 2) buffering data in order to accommodate printing to a medium (e.g., paper) with the MM 510. The electronic control system 560 is similar to the electronic control system 260 previously described with reference to FIGS. 2 and 3.

Tape-Type Media Applications

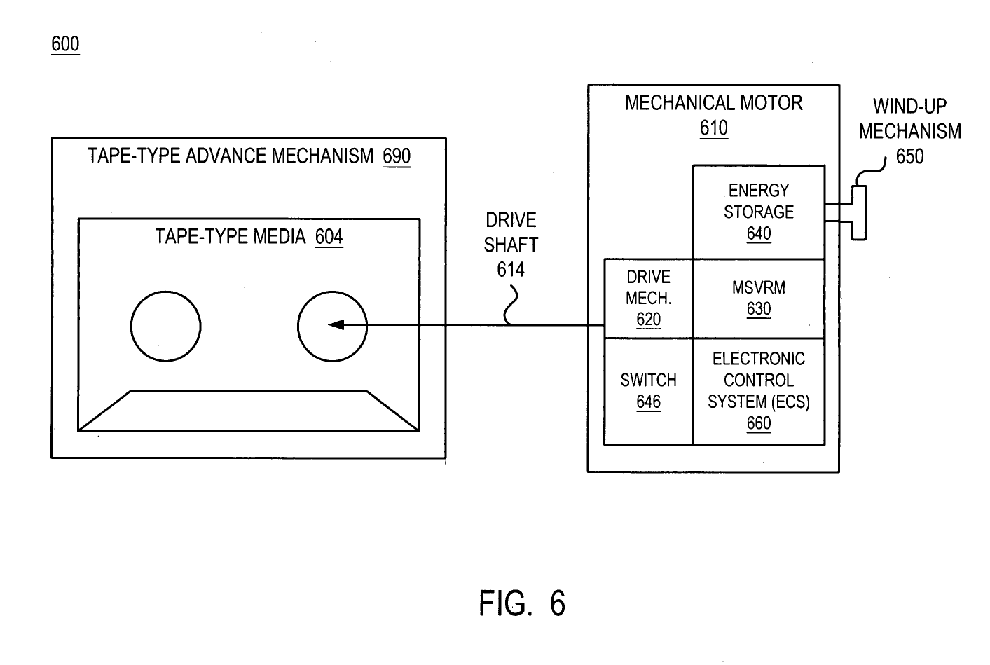

FIG. 6 illustrates a tape-type media player 600 that employs a mechanical motor 610 to advance a type-type media 604 according to one embodiment of the invention. The mechanical motor (MM) 610 moves or advances tape-type media 604 (e.g., audio cassettes, video cassettes) in the tape-type media player 600 according to one embodiment of the invention. The tape-type media player 600 includes a tape advance mechanism (TAM) 620 for advancing tape-type media 604. A mechanical motor 610 according to the invention is coupled to the tape advance mechanism 620 through a drive shaft 614 for advancing the tape-type media 604.

The tape-type media player 600 can be, but is not limited to an audio cassette tape player, video cassette tape player, a back-up tape player, a digital tape player, and an analog tape player. The tape-type media 604 can be, but is not limited to, audio cassette tapes, video cassette tapes, back-up tapes, digital tapes, and analog tapes. When the tape media is a cassette, the tape advance mechanism 620 can be, for example, a mechanism for engaging a take-up reel of the cassette.

The mechanical motor 610 includes a wind-up mechanism 650, a mechanical energy storage component 640, a drive mechanism 620, and optionally a mechanical speed variation compensation mechanism (MSVCM) 630, an electronic control system 660, and a switch 646. The construction and operation of the mechanical motor (MM) 610 are similar to the mechanical motors (110, 210, 510) according to the invention described previously. For example, the above-noted components of motor 610 operate and function in a manner similar to those elements described previously with common suffix numerals. For the sake of brevity, this description will not be repeated herein.

For example, the mechanical motor 610 can optionally include a mechanical speed variation compensation mechanism (MSVCM) 630 for mechanically compensating for variations in speed provided by the MM 610. For example, the MSVCM 630 can reduce the amount of speed variation so that the MM 610 can provide a more constant drive or rotational motion to drive shaft 614, for example.

Also, the tape-type media player 600 can optionally include an electronic control system 660 for 1) electrically compensating for variations in the speed provided by the MM 610 (e.g., by reducing the variations in the speed) and for 2) buffering data in order to accommodate playback of the tape or recording to the tape with the MM 610. The electronic control system 660 is similar to the electronic control system 260 previously described with reference to FIGS. 2 and 3.

Although the mechanical motor according to the invention have been described by the various embodiments shown in the figures (e.g., fans, digital media, analog media (e.g., tape-type media) and printers), other arrangements of the mechanical motor and components related thereto (e.g., energy storage mechanisms, mechanical coupling mechanisms, mechanical speed variation compensation mechanisms, and electrical data rate compensation mechanisms) can be devised in accordance with the teachings of the invention to provide non-electric power for other applications.

In the foregoing specification, the invention has been described with reference to specific embodiments thereof. It will, however, be evident that various modifications and changes may be made thereto without departing from the broader scope of the invention. The specification and drawings are, accordingly, to be regarded in an illustrative rather than a restrictive sense.

1. A fan for cooling at least one component in a portable electronic apparatus comprising:
a) a blade assembly that includes plurality of blades;
b) a mechanical motor for rotating the blade assembly; wherein the mechanical motor includes
a. a drive shaft coupled to the blade assembly;
b. a drive mechanism coupled to the drive shaft for imparting rotation motion thereto;
c. a wind-up mechanism for use by a person to apply human energy; and
d. an energy storage mechanism coupled to the handle for converting human energy into a mechanical energy and for storing the mechanical energy.

2. The fan of claim 1 wherein the mechanical motor further comprises:
e. a switch for turning the mechanical motor on and off;
wherein the switch is one of a mechanical switch and an electronic switch.

3. A media player comprising:
a) a media spinner for spinning media;
b) a mechanical motor coupled to the media spinner for rotating the media spinner; wherein the mechanical motor includes
a. a drive shaft coupled to the media spinner;
b. a drive mechanism coupled to the drive shaft for imparting rotational motion thereto;
c. a wind-up mechanism for use by a person to apply human energy;
d. an energy storage mechanism coupled to the handle for converting human energy into mechanical energy and for storing the mechanical energy.

4. The media player of claim 3 wherein the media player is one of a compact disc player, a floppy disk drive, a DVD player, a video game console, a record player, a digital media player, and an analog media player.

5. The media player of claim 3 wherein the media is one of a compact disc, a floppy disk, a DVD, a video game disc, a record, a digital media, and an analog media.

6. The media player of claim 3 wherein the mechanical motor further comprises:
e. a switch for turning the mechanical motor on and off;
wherein the switch is one of a mechanical switch and an electronic switch.

7. The media player of claim 3 wherein the mechanical motor further includes a mechanical speed variation compensation mechanism for mechanically compensating for variations in speed provided by the mechanical motor.

8. The media player of claim 3 wherein the mechanical motor further includes an electronic control system for electrically compensating for variations in speed provided by the mechanical motor.

9. The media player of claim 8 wherein the electronic control system for electrically compensating for variations in speed further includes a position sensor for providing positional information of the media with respect to a predetermined reference marking.

10. The media player of claim 8 wherein the electronic control system for electrically compensating for the variation in speed further includes a read buffer for temporarily storing data read from the media.

11. The media player of claim 8 wherein the electronic control system for electrically compensating for the variation in speed further includes a write buffer for temporarily storing data to be written to the media.

12. A printer apparatus comprising:
a) a printer component that requires motion; and
c) a mechanical motor for moving the printer component; wherein the mechanical motor includes
a. a drive shaft coupled to the printer component;
b. a drive mechanism coupled to the drive shaft for imparting rotation motion thereto;
c. a wind-up mechanism for use by a person to apply human energy; and
d. an energy storage mechanism coupled to the wind-up mechanism for converting human energy into a mechanical energy and for storing the mechanical energy.

13. The printer apparatus of claim 12 wherein the printer component includes one of a paper roller and a print head.

14. The printer apparatus of claim 12 wherein the mechanical motor further comprises:
e. a switch for turning the mechanical motor on and off;
wherein the switch is one of a mechanical switch and an electronic switch.

15. A tape-type media player comprising:
d) a tape advance mechanism for advancing a tape-type media;
e) a mechanical motor coupled to the tape advance mechanism for advancing the tape-type media; wherein the mechanical motor includes
a. a drive shaft coupled to the tape advance mechanism;
b. a drive mechanism coupled to the drive shaft for imparting rotation motion thereto;
c. a wind-up mechanism for use by a person to apply human energy; and
d. an energy storage mechanism coupled to the wind-up mechanism for converting human energy into a mechanical energy and for storing the mechanical energy.

16. The tape-type media player of claim 15 wherein the tape-type media player is one of an audio cassette tape player, video cassette tape player, a back-up tape player, a digital tape player, and an analog tape player.

17. The tape-type media player of claim 15 wherein the tape-type media is one of an audio cassette tape, video cassette tape, a back-up tape, a digital tape, and an analog tape.

18. The tape-type media player of claim 15 wherein the mechanical motor further comprises:
e. a switch for turning the mechanical motor on and off;
wherein the switch is one of a mechanical switch and an electronic switch.
